(19) United States
(12) Patent Application Publication
(10) Pub. No.: US 2006/0045159 A1
(43) Pub. Date: Mar. 2, 2006

(54) System and method for maintaining a purity level of a lasing gas

(75) Inventors: Leroy O. Thielman, Shoreview, MN (US); Timothy J. Callaghan, Roseville, MN (US); Christina M. Schober, Saint Anthony, MN (US); David D. Malenke, Maple Grove, MN (US); Britt A. Proctor, Elk River, MN (US); Daniel L. Sittler, Hugo, MN (US); Ying Tan, Arden Hills, MN (US); Michael A. McCoy, Burnsville, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 10/930,490

(22) Filed: Aug. 31, 2004

(51) Int. Cl. H01S 3/22

(52) U.S. Cl. 372/59

(57) ABSTRACT

An oxygen diffusion barrier is used to maintain a purity level of lasing gas in a ring laser gyroscope or other gas discharge device. The oxygen diffusion barrier reduces a release of contaminate gases into a cavity of the ring laser gyroscope and/or absorbs the contaminate gases in the cavity. The oxygen diffusion barrier may be formed on walls of the cavity before or after assembly of the ring laser gyroscope. Alternatively, a material may be applied to inside walls of a cathode mounted on a block of the ring laser gyroscope to maintain the purity level of the lasing gas. As a result of maintaining the purity level of the lasing gas, the ring laser gyroscope operates more efficiently.

### FIELD

The present invention relates generally to ring laser gyroscopes, and more particularly, relates to maintaining a purity level of a lasing gas in a ring laser gyroscope.

### BACKGROUND

A ring laser gyroscope detects and measures angular rates by measuring the frequency difference between two counter-rotating laser beams according to the Sagnac effect. The two laser beams simultaneously circulate in a cavity of the ring laser gyroscope with the aid of mirrors to reflect each laser beam around the cavity. The laser beams will ideally have identical frequencies when the ring laser gyroscope is at rest. However, if the ring laser gyroscope is rotated, the laser beams will have different frequencies. This frequency difference is measured to provide the rate of rotation.

The cavity is filled with a gas that is excited by an electric current passing between electrodes (cathodes and anodes) mounted on a block of the ring laser gyroscope. In a typical arrangement, a ring laser gyroscope has two anodes and one cathode mounted on the block of the ring laser gyroscope, but other applications employ different numbers of anodes and cathodes. When the electric potential becomes sufficiently large to create a population inversion within the lasing gas, a laser is generated. A typical lasing gas is a mixture of helium and neon, though other gases such as argon may be used.

The block of the ring laser gyroscope typically contains at least one getter to maintain a purity level of the lasing gas. The getter absorbs contaminants in the cavity, typically non-inert gases such as oxygen. If the non-inert gases are not removed from the cavity, the lasing gas may degrade, which reduces the efficiency of the laser. For example, when contamination is allowed to collect in the block, there may be a delay in an onset of lasing, which impacts a reaction time of the ring laser gyroscope. Degradation of the lasing gas may also impact the operational lifetime of the ring laser gyroscope.

However, in some applications the use of a getter to maintain the purity level of the lasing gas is not feasible. Therefore, it would be desirable to maintain the purity level of the lasing gas without the use of a getter.

### SUMMARY

A system and method for maintaining a purity level of lasing gas in a ring laser gyroscope or other gas discharge device is described. In one example, walls of a cavity in the ring laser gyroscope are at least partially coated with the oxygen diffusion barrier prior to assembly of the ring laser gyroscope. Material forming the oxygen diffusion barrier may be in a form of slurry, which may be applied to the walls of the cavity via painting, chemical vapor deposition, or other suitable process. Alternatively, the material forming the oxygen diffusion barrier may be in the form of a gas. The oxygen diffusion barrier may be composed of any material that reduces the release of and/or absorbs oxygen and/or other contaminant gases, but not the lasing gas. For example, the oxygen diffusion barrier may be composed of alumina or silicon nitride.

In another example, the oxygen diffusion barrier is formed after assembly of the ring laser gyroscope. A gas that creates the oxygen diffusion barrier may be injected into the ring laser gyroscope during vacuum fill station processing. For example, a nitrogen or ammonia gas may be injected into the ring laser gyroscope, which at least partially coats the walls of the cavity with a nitride layer. The nitride layer reduces the release of contaminant gases within the ring laser gyroscope. The gas injection into the ring laser gyroscope may occur at or above room temperature.

In another example, the inside walls of a cathode mounted on the ring laser gyroscope are at least partially coated with a metallic material. As the ring laser gyroscope is operated, an oxide layer is formed on the metallic coating. Ions within the lasing gas bombard the oxide layer, which causes the combined oxide/metallic coating to be sputtered onto an entrance port of the cathode, thereby trapping the oxygen contamination. The metallic coating may be chromium, and the coating may be applied using any appropriate coating method, such as sputtering.

These as well as other aspects and advantages will become apparent to those of ordinary skill in the art by reading the following detailed description, with reference where appropriate to the accompanying drawings. Further, it is understood that this summary is merely an example and is not intended to limit the scope of the invention as claimed.

### BRIEF DESCRIPTION OF THE DRAWINGS

Preferred embodiments are described below in conjunction with the appended drawing figures, wherein like reference numerals refer to like elements in the various figures, and wherein:

FIG. 1 is a top view of a typical ring laser gyroscope;

FIG. 2 is a top view of the ring laser gyroscope shown in FIG. 1 with an oxygen diffusion barrier according to an example; and

FIG. 3 is a top view of the ring laser gyroscope shown in FIG. 1 with a material coating cathode walls according to an example.

### DETAILED DESCRIPTION

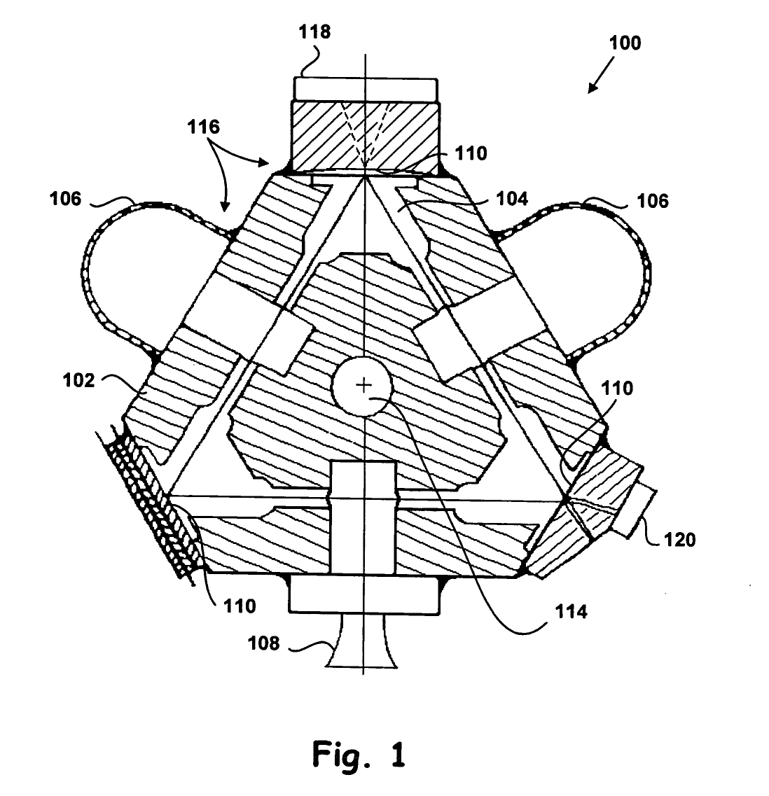

FIG. 1 shows a top view of a ring laser gyroscope 100. The ring laser gyroscope 100 consists of a block 102, a cavity 104, at least one cathode 106, at least one anode 108, at least one mirror 110, and a mounting structure 114. FIG. 1 depicts the ring laser gyroscope 100 as having two cathodes 106 and one anode 108; however, other configurations of electrodes may be used. Further, FIG. 1 depicts three mirrors 110 in the ring laser gyroscope 100; however, other mirror configurations may be used. The ring laser gyroscope 100 may have additional components, such as a detector 118 designed to measure the frequency difference between a laser beam circling clockwise around the cavity 104 and a laser beam circling counter-clockwise around the cavity 104, and detector 120 designed to measure total power in both the clockwise circling laser beam and the counter-clockwise circling laser beam.

The block 102 may be constructed of BK7, a hard borosilicate crown glass; however, other block materials may also be suitable. The block 102 is mounted on the mounting structure 114. The mounting structure 114 is typically a dither motor. Other mounting structures may be used. The electrodes (i.e., cathodes and anode) 106, 108 are mounted on the block 102. Electrode seals 116 are typically located between the block 102 and each of the electrodes 106, 108. The electrode seals 116 may be frit seals; however, other seal materials may also be used to construct the electrode seals 116.

The cavity 104 is located within the block 102. The mirrors 110 are used to direct the laser beams around the cavity 104. The lasing gas used in a ring laser gyroscope 100 may be a single inert gas or a combination of inert gases. If the lasing gas becomes contaminated, the reaction time of the ring laser gyroscope 100 may be impacted (e.g., onset of lasing may be delayed), degrading the performance of the ring laser gyroscope 100. A common contaminant of the lasing gas is oxygen. By reducing the amount of oxygen in the cavity 104, a purity level of the lasing gas may be maintained, allowing for the proper operation of the ring laser gyroscope 100.

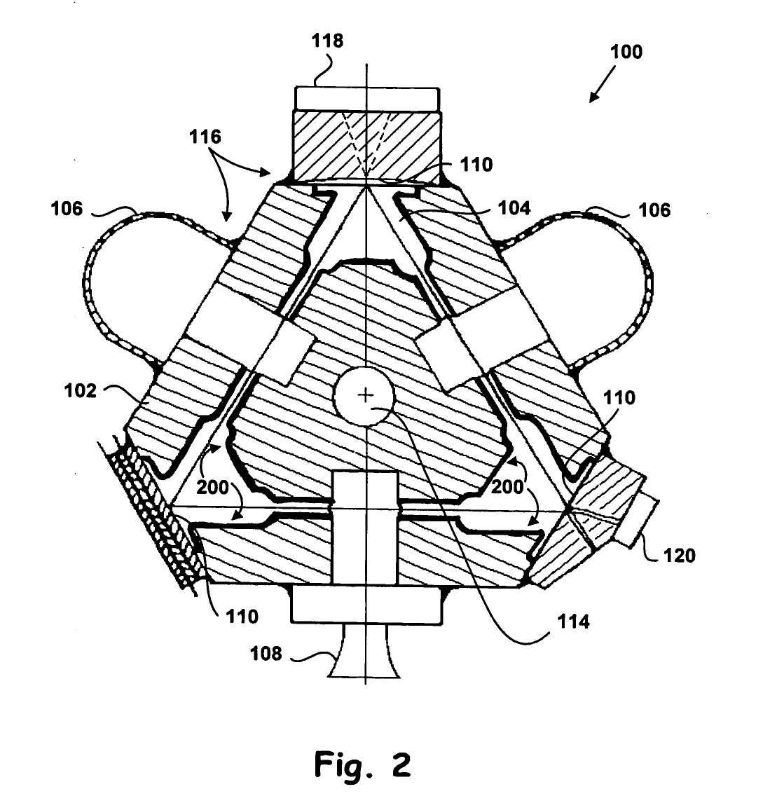

FIG. 2 is a top view of the ring laser gyroscope 100 shown in FIG. 1 with an oxygen diffusion barrier 200 coated on walls of the cavity 104. While FIG. 2 depicts all the walls of the cavity 104 coated with the oxygen diffusion barrier 200, less than all the walls may be coated. Partially coating the walls of the cavity 104 with the oxygen diffusion barrier 200 may be sufficient to maintain the purity level of the lasing gas.

The walls of the cavity 104 may be at least partially coated with the oxygen diffusion barrier 200 prior to and/or after assembly of the ring laser gyroscope 100. When the oxygen diffusion barrier 200 is formed on the walls of the cavity 104 prior to assembly of the ring laser gyroscope 100, a material used for forming the oxygen diffusion barrier 200 may be in a form of a slurry (i.e., a mixture of a liquid and a solid) or a gas.

The slurry may be applied to the walls of the cavity 104 by painting the slurry onto the walls of the cavity 104. After at least partially coating the walls of the cavity 104 with the slurry, the ring laser gyroscope 100 may be fired to harden the slurry, forming the oxygen diffusion barrier 200. Alternatively, the material used for forming the oxygen diffusion barrier 200 may be applied to the walls of the cavity 104 using chemical vapor deposition or other suitable process.

The slurry may be any material that reduces the release of and/or absorbs oxygen and/or other contaminant gases, but not the lasing gas. For example, the slurry may be composed of alumina (i.e., aluminum oxide, Al₂O₃). Other materials including, but not limited to, Cerablak™ (an oxide material composed of aluminum, phosphorous, and oxygen), may also be used as a slurry material for creating the oxygen diffusion barrier 200.

The thickness of the oxygen diffusion barrier 200 depicted in FIG. 2 is exaggerated for illustrative purposes. The thickness of the oxygen diffusion barrier 200 may depend on the type of slurry material. For example, a thickness of approximately 9000 Angstroms may be sufficient for an oxygen diffusion barrier 200 composed of alumina, while a thickness of approximately 400 Angstroms may be sufficient for an oxygen diffusion barrier 200 composed of Cerablak™. These barrier thickness examples are provided for illustrative purposes only and are not intended to limit the scope of the invention.

The oxygen diffusion barrier 200 may also be formed prior to assembly of the ring laser gyroscope 100 using a gas. The walls of the cavity 104 may be exposed to a gas that causes a nitride layer (e.g., silicon nitride) to form on the walls. The nitride layer reduces the release of contaminant gases within the cavity 104. For example, the gas may be nitrogen gas, ammonia gas, or other gas that forms the nitride layer. The walls of the cavity 104 may be exposed to the gas at or above room temperature. (Room temperature is defined herein as a normal temperature of a room in which people live. As defined, room temperature is not limited to a single value of temperature, but encompasses a range of temperatures.) A nitride layer having a thickness of approximately 50 Angstroms may be sufficient for the oxygen diffusion barrier 200. However, other nitride layer thicknesses may also be suitable.

The walls of the cavity 104 may also be at least partially coated with the oxygen diffusion barrier 200 after assembly of the ring laser gyroscope 100. In this example, a gas may be injected into the ring laser gyroscope 100 in a similar manner as the injection of the lasing gas. More specifically, the gas used to form the oxygen diffusion barrier 200 may be applied during vacuum fill station processing.

The gas may be nitrogen gas, ammonia gas, or any other gas that at least partially coats the walls of the cavity 104 with a nitride layer. The oxygen diffusion barrier 200 may be composed of silicon nitride. The injection of gas into the ring laser gyroscope 100 may occur at or above room temperature.

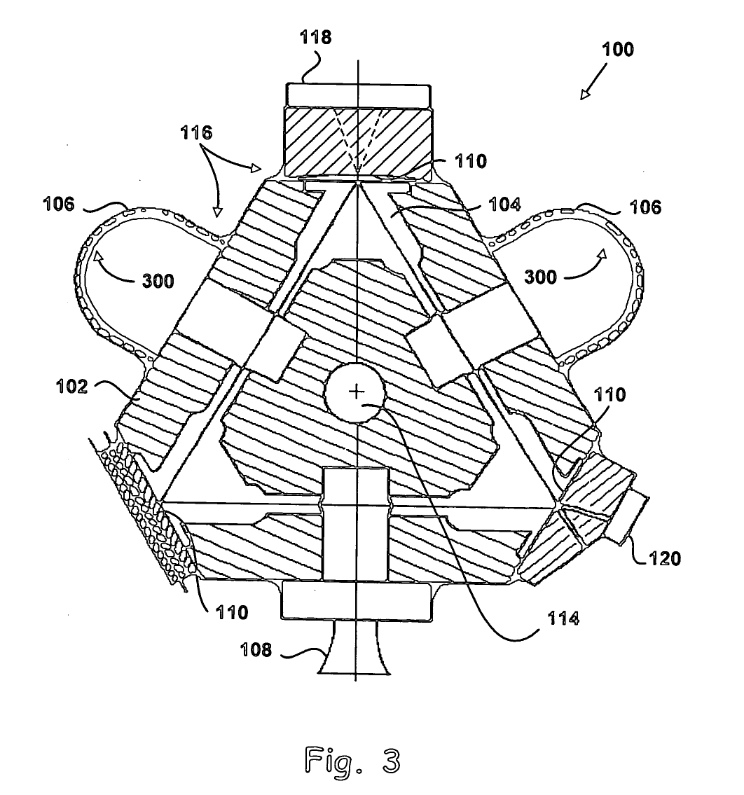

FIG. 3 is a top view of the ring laser gyroscope 100 shown in FIG. 1 with a metallic material 300 coating the inside walls of the cathodes 106. As the ring laser gyroscope is operated, an oxide layer is formed on the metallic material 300. Ions within the lasing gas bombard the oxide layer, which causes the combined oxide/metallic coating 300 to be sputtered onto an entrance port of the cathode, thereby trapping the oxygen contamination.

By trapping the oxygen contamination, contaminant levels are maintained at a reduced level in the cavity 104. While FIG. 3 depicts all of the walls of the cathodes 106 coated with the metallic material 300, less than all of the walls may be coated. Partially coating the walls of the cathodes 106 with the metallic material 300 may be sufficient to maintain the purity level of the lasing gas.

The cathode walls may be coated with the metallic material 300, such as chromium, using any appropriate coating method. In a preferred embodiment, the cathodes 106 are cleaned and then sputter coated with the metallic material 300. The sputtering of the metallic material 300 occurs in a vacuum chamber prior to attachment of the cathodes 106 to the block 102. Other coating methods may also be used for at least partially coating the cathode walls.

The thickness of the metallic material 300 depicted in FIG. 3 is exaggerated for illustrative purposes. A metallic coating having a thickness of approximately 10,000 Angstroms may be sufficient for the coating. However, other metallic coating thicknesses may also be suitable.

By coating the walls of the cavity 104 and/or the cathodes 106, the purity level of the lasing gas may be maintained at a level such that the quantity of contaminants in the lasing gas is kept sufficiently low as to not affect the performance of the ring laser gyroscope 100. Additionally, the purity of the lasing gas may be maintained without the use of a getter. As a result, the ring laser gyroscope 100 operates without a delay in the onset of lasing, which may occur when contamination in the lasing gas accumulates.

Variations to the exemplary embodiments may be made without departing from the intended scope of the invention. It is within the scope of this invention to employ these methods in other lasing applications in addition to what was demonstrated here using a ring laser gyroscope. For example, these methods may be applicable for use in any gas discharge device. The claims should not be read as limited to the described order or elements unless stated to that effect. Therefore, all embodiments that come within the scope and spirit of the following claims and equivalents thereto are claimed as the invention.

We claim:

1. A system for maintaining lasing gas purity, comprising in combination:
a gas discharge device having a cavity; and
an oxygen diffusion barrier at least partially coating walls of the cavity, wherein the oxygen diffusion barrier reduces contaminants in the lasing gas.

2. The system of claim 1, wherein the gas discharge device is a ring laser gyroscope.

3. The system of claim 1, wherein the oxygen diffusion barrier reduces a release of a contaminant gas in the cavity.

4. The system of claim 1, wherein the oxygen diffusion barrier absorbs a contaminant gas in the cavity.

5. The system of claim 1, wherein the oxygen diffusion barrier is formed on the walls of the cavity prior to assembly of the gas discharge device.

6. The system of claim 5, wherein the oxygen diffusion barrier is alumina.

7. The system of claim 5, wherein the oxygen diffusion barrier is an oxide material composed of aluminum, phosphorous, and oxygen.

8. The system of claim 5, wherein the oxygen diffusion barrier is formed by applying a slurry to the walls of the cavity.

9. The system of claim 8, wherein the slurry is painted on the walls of the cavity and the gas discharge device is fired to harden the slurry.

10. The system of claim 5, wherein the oxygen diffusion barrier is formed by applying a material to the walls of the cavity using chemical vapor deposition.

11. The system of claim 5, wherein the oxygen diffusion barrier is formed by exposing the walls of the cavity to a gas selected from the group consisting of nitrogen gas and ammonia gas.

12. The system of claim 11, wherein the oxygen diffusion barrier is silicon nitride.

13. The system of claim 11, wherein the walls of the cavity are exposed to the gas at room temperature.

14. The system of claim 11, wherein the walls of the cavity are exposed to the gas at a temperature above room temperature.

15. The system of claim 1, wherein the oxygen diffusion barrier is formed on the walls of the cavity after assembly of the gas discharge device.

16. The system of claim 15, wherein a gas is injected into the gas discharge device forming the oxygen diffusion barrier on the walls of the cavity.

17. The system of claim 16, wherein the gas is selected from the group consisting of nitrogen gas and ammonia gas.

18. The system of claim 16, wherein the oxygen diffusion barrier is silicon nitride.

19. The system of claim 16, wherein the gas is injected into the assembled gas discharge device at room temperature.

20. The system of claim 16, wherein the gas is injected into the assembled gas discharge device at a temperature above room temperature.

21. A system for maintaining lasing gas purity, comprising in combination:
a gas discharge device having at least one cathode; and
a metallic material at least partially coating walls of the at least one cathode, wherein the material reduces contaminants in the lasing gas.

22. The system of claim 21, wherein the metallic material is composed of chromium.

23. The system of claim 21, wherein the metallic material is sputtered onto the walls of the at least one cathode in a vacuum chamber prior to assembly of the gas discharge device.

24. A method for maintain laser gas purity comprising forming an oxygen diffusion barrier on walls of a cavity located in a gas discharge device.

25. The method of claim 24, wherein the gas discharge device is a ring laser gyroscope.

26. The method of claim 24, wherein the oxygen diffusion barrier reduces a release of a contaminant gas in the cavity.

27. The method of claim 24, wherein the oxygen diffusion barrier absorbs a contaminant gas in the cavity.

28. The method of claim 24, wherein forming the oxygen diffusion barrier is performed prior to assembly of the gas discharge device.

29. The method of claim 28, wherein the oxygen diffusion barrier is alumina.

30. The method of claim 28, wherein the oxygen diffusion barrier is an oxide material composed of aluminum, phosphorous, and oxygen.

31. The method of claim 28, wherein forming the oxygen diffusion barrier includes applying a slurry to the walls of the cavity.

32. The method of claim 31, wherein applying the slurry includes painting the slurry onto the walls of the cavity and firing the gas discharge device to harden the slurry.

33. The method of claim 28, wherein forming the oxygen diffusion barrier includes using chemical vapor deposition to at least partially coat the walls of the cavity with a material.

34. The method of claim 24, wherein forming the oxygen diffusion barrier includes exposing the walls of the cavity to a gas selected from the group consisting of nitrogen gas and ammonia gas.

35. The method of claim 34, wherein the oxygen diffusion barrier is silicon nitride.

36. The method of claim 34, wherein exposing the walls of the cavity occurs at room temperature.

37. The method of claim 34, wherein exposing the walls of the cavity occurs at a temperature above room temperature.

38. The method of claim 24, wherein forming the oxygen diffusion barrier occurs after assembly of the gas discharge device.

39. The method of claim 38, wherein forming the oxygen diffusion barrier includes injecting a gas into the gas discharge device.

40. The method of claim 39, wherein the gas is selected from the group consisting of nitrogen gas and ammonia gas.

41. The method of claim 39, wherein the oxygen diffusion barrier is silicon nitride.

42. The method of claim 39, wherein injecting the gas into the gas discharge device occurs at room temperature.

43. The method of claim 39, wherein injecting the gas into the gas discharge device occurs at a temperature above room temperature.

44. A method for maintain laser gas purity comprising applying a metallic material to walls of at least one cathode mounted on a gas discharge device.

45. The method of claim 44, wherein the metallic coating is composed of chromium.

46. The method of claim 43, wherein applying the metallic material includes sputtering the metallic material on the walls of the at least one cathode prior to assembly of the gas discharge device.
